(19) United States
(12) Patent Application Publication
(10) Pub. No.: US 2008/0138606 A1
(43) Pub. Date: Jun. 12, 2008

(54) Antireflective Laminate

(75) Inventors: Toshio Yoshihara, Tokyo-To (JP); Norinaga Nakamura, Tokyo-To (JP); Koichi Mikami, Tokyo-To (JP); Midori Nakajo, Tokyo-To (JP); Seiji Shinohara, Tokyo-To (JP)

Correspondence Address: BURR & BROWN, PO BOX 7068, SYRACUSE, NY, 13261-7068, US

(73) Assignee: Dai Nippon Printing Co,. Ltd., Tokyo (JP)

(21) Appl. No.: 10/594,694

(22) PCT Filed: Mar. 3, 2005
(86) PCT No.: PCT/JP2005/003581

§ 371 Date: Sep. 7, 2007

(30) Foreign Application Priority Data
Mar. 31, 2004 (JP) 2004-105739
Sep. 29, 2004 (JP) 2004-285050

(51) Int. Cl. B32B 5/16

(52) U.S. Cl. 428/327; 428/323; 428/331

(57) ABSTRACT

Disclosed is an antireflective laminate that has significantly improved water resistance, alkaline resistance, and wetting resistance, and has improved visibility and scratch resistance. The antireflective laminate comprises a light-transparent base material and a low-refractive index layer provided on the light-transparent base material, wherein the low-refractive index layer is provided directly on a surface of the light-transparent base material or is provided on the outermost surface of one or two or more optional layers provided on the surface of the light-transparent base material, and the low-refractive index layer comprises hydrophobitized fine particles having an average particle diameter of not less than 5 nm and not more than 300 nm, and a binder.

### TECHNICAL FIELD

1. Field of Invention

The present Invention relates to an antireflective laminate possessing excellent water resistance, wetting resistance and alkaline chemical resistance.

2. Background Art

Image display surfaces in image display devices such as liquid crystal displays (LCDS) or cathode ray tube display devices (CRTs) are required to reduce the reflection of light applied from an external light source such as a fluorescent lamp and thus to enhance the visibility of the image. To meet this demand, an antireflective film having a reduced reflectance achieved by covering the surface of a transparent object with a transparent film having a low refractive index has been provided to reduce the reflection of light from an image display surface in the image display device and thus to improve the visibility,

The (low) refractive Index layer is formed on the antireflective film by coating a coating liquid comprising a mixture of fine particles with a binder such as a photocuring resin onto a base material surface and subjecting the coating to photocuring or the like. The refractive index layer, however, has low mechanical strength and, when provided on the surface of an image display device, often causes damage due to poor scratch resistance.

On the other hand, Japanese Patent Laid-Open No. 79600/2002 discloses that the low refractive index in the refractive index layer and the strength of the coating film can simultaneously be realized by adopting a low-refractive index layer that is formed of silica sol particles and a polyfunctional acryl monomer, has a surface roughness, regulated on nanoscale, and has a nanoporous structure. In this antireflective film, however, the alkali resistance and water resistance of the outermost surface were unsatisfactory. Further, Japanese Patent Laid-Open No. 202406/2003 discloses that the provision of a water-repellent/oil-repellent anti-fouling layer on the surface of a low-refractive index layer using silica fine particles having a low-refractive index can realize low-refractive index and anti-fouling properties. In this anti-reflective film, however, the alkali resistance of hydrophilic silica fine particles present near the outermost surface of the low-refractive index layer and the water resistance of the inside of the coating film are unsatisfactory.

Accordingly, the development of an antireflective laminate, which has a low-refractive index and mechanical strength and comprises a low-refractive index layer having both alkali resistance and water resistance, has been still demanded.

### RELATED APPLICATIONS

This application is based upon and claims the benefit of priority from the prior Japanese Patent Application No. 105739/2004 and No. 28505012004, the entire contents of which are incorporated herein by reference.

### DISCLOSURE OF THE INVENTION

The present Inventors have aimed at a constituent material of a low-refractive index layer constituting an anti-reflective laminate at the time of the present invention and, as a result, have found that the adoption of fine particles having a specific average particle diameter and subjected to hydrophobitization treatment as a constituent material of the low-refractive index layer can realize a significant improvement in water resistance, alkali resistance, and wetting resistance in the outermost surface of the antireflective laminate. Accordingly, the present Invention is to provide an antireflective laminate that has significantly improved water resistance, alkali resistance, and wetting resistance and has improved visibility and scratch resistance.

Thus, according to the present invention, there is provided an antireflective laminate comprising
a light-transparent base material and a low-refractive index layer provided on the light-transparent base material, wherein
said low-refractive index layer is provided directly on a surface of the light-transparent base material or is provided on the outermost surface of one or two or more optional layers provided on the surface of the light-transparent base material, and
said low-refractive index layer comprises hydrophobitized fine particles having an average particle diameter of not less than 5 nm and not more than 300 nm, and a binder.

According to the present invention, the adoption or a low-refractive index layer comprising hydrophobitized fine particles as an indispensable layer construction in the antireflective laminate can realize low-refractive index, water resistance, alkali resistance, and wetting resistance, whereby an antireflective laminate having significantly improved visibility and durability (scratch resistance, high hardness and high strength) can be provided.

### BEST MODE FOR CARRYING OUT THE INVENTION

Antireflective Laminate

In the antireflective laminate according to the present invention, a low-refractive index layer is provided directly on a light-transparent base material, or alternatively is provided on the outermost surface of one or a plurality of optional layers provided on the surface of the light-transparent base material.

1. Low-Refractive Index Layer

The low-refractive index layer may comprise hydrophobitized fine particles, a binder, and optional components. The low-refractive index layer may have a single-layer structure formed of a composition comprising fine particles and a binder, or alternatively may be a multilayer structure of a laminate of a plurality of layers formed of compositions having different formulations.

In a preferred embodiment of the present invention, the low-refractive index layer comprises a layer formed of the fine particles and the binder (a first layer) and a layer formed of the binder alone (a second layer) provided on the first layer, and the outermost surface of the low-refractive index layer has been rendered smooth. In this case, the thickness of the second layer is more preferably not more than 30 nm. When the thickness of the second layer is not more than 30 nm, there is substantially no influence on a spectral curve even though the refractive index is higher than that of the low-refractive index layer, Further, satisfactory flatness can be realized.

In this case, preferably, the second layer is formed so as to cover the fine particles exposed on the surface of the first layer, and the low-refractive index layer has a desired thickness. More specifically, the first layer and the second layer are formed so that the ratio of the thickness of the first layer to the thickness of the second layer is 3:2 (120 nm : 80 nm), preferably 2:1 (100 nm , 50 nm), more preferably 3:1 (99 nm : 33 nm).

Hydrophobitization of Fine Particles

In the present invention, hydrophobitized fine particles are utilized. Fine particles to be hydrophobitized per se may be hydrophobilic or nonhydrophobic, or may have both hydrophobilic and nonhydrophobic properties. The hydrophilization may be carried out on the whole surface of the fine particles or may be further carried out to an internal structure of the fine particles. The fine particles may be hydrophobitized by the following method.

1) Hyrophobitization with Low-Molecular Organic Compound

The hydrophilization may be carried out by a method which comprises dispersing fine particles (for example, silica fine particles) in a solution of a low-molecular organic compound in an organic solvent and then fully evaporating and removing the organic solvent to treat (cover) the fine particles with the low-molecular organic compound and to hydrophobitize the fine particles.

An organic compound having a molecular weight (number average molecular weight as determined using polystyrene as a standard substance) of not more than 5000, preferably not more than 3000, may be mentioned as the low-molecular organic compound, Specific examples thereof include low-molecular organic carboxylic acids such as stearic acid, lauric acid, oleic acid, linolic acid, and linoleic acid, or low-molecular organic amines.

2) Surface Covering Hydrophobitization with Polymeric Compound

Surface covering hydrophobitization with a la polymeric compound is a method in which at least a part of the surface of the fine particles is covered with a polymeric compound. Specific examples of such methods include a method in which a monomer is adsorbed selectively on the surface of fine particles followed by increasing of the molecular weight, an emulsion polymerization method in the presence of fine particles, a micro-encapsulation method, a dispersion polymerization method, a suspension polymerization method, a seed polymerization method, a spray drying method, a cold granulation method, a method using a supercritical fluid, a heteroaggregation method, a dry-type fine particle aggregation method, a phase separation method (a coacervation method), an interfacial polymerization method, a liquid drying method (an interfacial precipitation method), an orifice method, an interfacial inorganic reaction method, and an ultrasonication method. At least a part of the surface or the fine particles can be covered with a desired polymeric compound by any of the above methods.

The polymeric compound has a molecular weight (number average molecular weight using polystyrene as a standard substance) of not less than 5000, preferably not less than 10000. Polymeric compounds having a higher level of hydrophobicity are more preferred. Specific examples of such polymeric compounds include polyolefin resins, polystyrene, resins containing a halogen such as a fluorine atom, acrylic resins, nitrogen-containing resins, polyvinyl ethers, polyamide resins, polyester resins, polycarbonate resins, silicone resins, PPO resins, phenolic resins, xylone resins, amino resins, acetal resins, polyether resins, epoxy resins, penton resins, natural rubbers, synthetic rubbers per se and/or synthetic rubber composited products (blends or copolymers), or product by increasing the molecular weight of coupling agents described in 3) below, or organic-inorganic hybrid polymer compounds. Specific examples of monomers of organic-inorganic hybrid polymers include organometal compounds such as alkoxysilanes which are used in combination with monomers or polymers exemplified in 4) below. Specific examples of preferred organic-inorganic hybrid polymers include commercially available products such as Compocerane or Urearnou (tradename: manufactured by Arakewa Chemical Industries, Ltd.).

3) Hydrophobitization Treatment with Coupling Agent

Hydrophobitization treatment with coupling agent is a fine particle hydrophobitizatlon method that is the same as the method described in 1) above, except that a coupling agent is used instead of the low-molecular organic compound. A wide variety of coupling agents are usable. Preferred are alkyl chain-containing silane coupling agents, fluorine atom-containing silane coupling agents (fluorosilane coupling agents). When the surface of the fine particles (preferably inorganic fine particles) Is hydrophobitized with these coupling agents, the hydrophobitized fine particles have excellent compatibility particularly with fluorine-containing binders. As a result, whitening of the low-refractive index layer can be effectively prevented.

Specific examples of alkyl chain-containing silane coupling agents include methyltriethoxysilane, trimethyltrichlorosilane, ethyltriethoxysilane, ethyltrichlorosilane, phenyltriethoxysilane, phenyltrichlorosilane, dimethyldiethoxysilane, dimethyidichlorosilane, 3-glycidoxy propyltrimethoxysilane, 3-glycidoxy propylmethyidimethoxysilane, 2-(3,4-epoxycyclohexyl)ethyltrimethoxysilane, 3-aminopropyltriethoxysilane, 3-amlnopropyltrimethoxysilane, N-(2-amincethyl)3-amlnopropylmethyidiethoxysilane, 3-merca ptopropyltrimethoxysi lane, vl nyltrimethoxysilane, vinyltriethoxysilane, vlnyltris(2-methoxyethoxy)silane, and 3-methacryloxypropyltrimethoxysilane.

Specific examples of fluorosilane coupling agents include fluoroalkylsilane coupling agents (tradename; TSL8262, TSL8257, TSL8233, TSL8231, etc.) manufactured by GE Toshiba Silicone Co., Ltd., or perfluoropolyether group-containing alkoxysilanes. Further, coupling agents containing elements other than silicon In such an amount that does not sacrifice the refractive index, are also usable. Specific examples of such coupling agents include titanate coupling agents exemplified, for example, by PLENACT KR-TTS, PLENACT KR-46B, PLENACT KR-55, PLENACT KR-41B, PLENACT KR-38S, PLENACT KR-138S. PLENACT KR-238S, PLENACT KP-338X, PLENACT KR-44, PLENACT KR-9SA, and PLENACT KR-ET (tradename) that are commercially available from Ajinomoto Co., Inc.; and metal alkoxides such as tetramethoxytitanium, tetraethoxytitanium, tetraisopropoxytitanium, tetra-n-propoxytitanium, tetra-n-butoxytitanium, tetra-sec-butoxytitanium, and tetra-tert-butoxytitanium.

4) Hydrophobitization by Grafting of Hydrophobtic Polymer

Methods usable for hydrophobitization by grafting of hydrophobtic polymer can be roughly classified into the following three methods.

4a) Method for Capturing Growth End of Polymer by Fine Particles

Hydrophilic groups present on the surface of fine particles (for example, hydroxyl group (—OH) present on the surface of silica) function to capture active species such as radicals. Accordingly, fine particles are hydrophobitized by polymerizing a polyfunctional monomer or oligomer in the presence of such fine particles, or by adding inorganic ultrafine particles to a polyfunctional monomer or oligomer polymerization system, to attach the monomer, oligomer or polymer containing a polymerizable functional group onto the surface of the fine particles.

4b) Method for Initiating Polymerization Reaction from Surface of Fine Particles

A polymerization initiation active species such as a radical polymerization initiator is previously formed on the surface of fine particles, for example, silica, and a polymer is allowed to grow from the surface of the fine particles using a polyfunctional monomer or oligomer. According to this method, a high-molecular weight polymerization reactive polymer chain can easily be obtained.

4c) Method for Bonding Hydrophilic Groups on Surface of Fine Particles to Reactive Group-Containing Polymer

A polymer containing a bi- or higher functional reactive group is used. Specific methods include a method in which hydroxyl group of fine particles (for example, hydroxyl groups on silica surface) is bonded directly to a reactive group in the polymer end, and a method in which a reactive group at the polymer end and/or hydrophilic groups in the fine particles are bonded to other reactive group followed by bonding of both of them to each other.

Among the above methods, method 4c) is preferred, because this method can use a wide variety of polymers, is relatively simple in operation, and can realize good bonding efficiency. In this method, since a dehydration polycondensation reaction between hydroxyl groups on the surface of fine particles and a reactive group-containing polymer is utilized, dispersion of the fine particles (for example, silica fine particles) in a polymer and its solution followed by heating at suitable temperature for a proper period of time is necessary. For example, in the case of silica, heating generally at 80° C. or above for 3 hr or longer is preferred, although the conditions vary depending upon the amounts of silica and the polymer.

Fine particles can be hydrophobitized by the above methods 1) to 4). Specific preferred examples of the present invention will be described. When the surface of silica is hydrophobitized, preferably, the above hydrophobic compound is present in an amount of not less than 1 part by weight based on 100 parts by weight of silica. Further, the number average molecular weight of the graft part of the polymer present on the silica surface is preferably in the range of 300 to 20000. The amount of the polymerizable functional group attached to silica can be measured by elementary analysis.

Fine Particles

The fine particles may be formed of an inorganic material or an organic material, and examples thereof include fine particles of metals, metal oxides, and plastics. Preferred are silicon oxide (silica) fine particles. The silica fine particles can impart a desired refractive index while suppressing an increase in refractive index of the binder. The silica fine particles may be in any form such as crystalline, sol, or gel form. Further, the silica fine particles may be a commercially available product, and preferred examples thereof include Aerosil (manufactured by Degussa) and Colloidal silica (manufactured by Nissan Chemical Industries Ltd.).

In a preferred embodiment of the present invention, “void-containing fine particles” are utilized. The “void-containing fine particles” can lower the refractive index while maintaining the strength of the lower-refractive index layer. In the present invention, the expression “void-containing fine particles” refers to fine particles that have a structure containing gas filled into fine particles and/or a gas-containing porous structure and have a refractive index which is lowered inversely proportionally to the proportion of gas in the fine particles as compared with the refractive index of the fine particles per se. Further, in the present invention, the fine particles include those which can form a nanoporous structure in at least a part of the inside and/or surface of the fine particle depending upon the form, structure, aggregation state, and dispersion state of the fine particles within the coating film.

Specific examples of preferred void-containing inorganic fine particles include silica fine particles prepared by a technique disclosed in Japanese Patent Laid-Open No. 233611/2001. The void-containing silica fine particles can easily be produced, and the hardness of the void-containing silica fine particles per se is high. Therefore, when a lower-refractive index layer is formed of a mixture of the void-containing silica fine particles with a binder, the layer strength can be improved and the refractive index can be regulated to fall within a range of about 1.20 to 1.45. In particular, specific examples of preferred void-containing organic fine particles include empty polymer fine particles prepared by a technique disclosed in Japanese Patent Laid-Open No. 80503/2002.

Fine particles which can form a nanoporous structure in at least a part of the inside and/or surface of the coating film include, in addition to the above silica fine particles, sustained release materials which have been produced for increasing the specific surface area and adsorb various chemical substances in a packing column and a porous part provided on the surface thereof, porous fine particles for catalyst fixation purposes, or dispersions or aggregates of empty fine particles to be incorporated in insulating materials or low-permittivity materials. Specific examples thereof include those in a preferred particle diameter range of the present invention selected from commercially available products, for example, aggregates of porous silica fine particles selected from Nipsil or Nipgel (tradenames, manufactured by Nippon Silica Industrial Co., Ltd.), Colloidal silica (tradename) UP series, manufactured by Nissan Chemical Industries Ltd. having a structure in which silica fine particles are connected to one another in a chain form.

The average particle diameter of the fine particles is not less than 5 nm and not more than 300 nm. Preferably, the lower limit is 8 nm, and the upper limit is 100 nm. More preferably, the lower limit is 10 nm, and the upper limit is 80 nm. When the average particle diameter of the fine particles is in the above-defined range, excellent transparency can be imparted to the lower-refractive index layer.

Binder

The binder contains a monomer having, in one molecule, three or more functional groups curable upon exposure to an ionizing radiation. The monomer used in the present invention contains an ionizing radiation curable functional group (hereinafter often referred to as “ionizing radiation curable group”) and a heat curable functional group (hereinafter often referred to as “heat curable group”). Accordingly, when a composition (coating liquid) containing this monomer is coated onto the surface of an object to form a coating which is dried and is then exposed to an ionizing radiation or is then exposed to an ionizing radiation with heating, a chemical bond such as a crosslinking bond can easily be formed within the coating film and, consequently, the coating film can be efficiently cured.

The “ionizing radiation curable group” contained in this monomer is a functional group that, upon exposure to an ionizing radiation, can allow a reaction for increasing the molecular weight such as polymerization or crosslinking to proceed to cure the coating film. Examples of such groups include those that can allow the reaction to proceed by a reaction form, for example, a polymerization reaction such as photoradical polymerization, photocation polymerization, or photoanlon polymerization, or addition polymerization or polycondensation which proceeds through photodimerization. Among them, ethylenically unsaturated bonding groups such as acryl, vinyl or ally groups are particularly preferred, because they cause a photoradical polymerization reaction directly upon exposure to an ionizing radiation such as ultraviolet light or electron beams or indirectly through the action of an initiator and are relatively easy in handling including the step of photocuring.

The “heat curable group” which may be contained in the monomer component is a functional group that, upon heating, can allow a reaction for increasing the molecular weight such as polymerization or crosslinking with an identical functional group or other functional group to proceed to cause curing. Specific examples of such groups include alkoxy, hydroxyl, carboxyl, amino, epoxy, and hydrogen bond forming groups. Among these functional groups, the hydrogen bond forming group is preferred, because, when the fine particles are inorganic ultrafine particles, the hydrogen bond forming group is also excellent in affinity for hydroxyl groups present on the surface of the fine particles and can improve the dispersibility of the inorganic ultrafine particles and aggregates thereof in the binder. Among hydrogen bond forming groups, the hydroxyl group is particularly preferred for the following reasons. Specifically, the hydroxyl group can easily be introduced into the binder component, can realize storage stability of the coating composition, can realize the formation, upon heat curing, of a covalent bond with hydroxyl groups present on the surface of inorganic fine particles having voids, allows the void-containing fine particles to function as a crosslinking agent, and can realize a further improvement in coating film strength. In order to satisfactorily lower the refractive index of the coating film, the refractive index of the monomer component is preferably not more than 1.65.

A monomer component having two or more ionizing radiation curable groups per molecule may be mentioned as the binder for the coating composition used in the formation of the low-refractive index layer in the antireflective laminate according to the present invention. This is preferred from the viewpoints of improving the crosslinking density of the coating film and improving the film strength or hardness.

In order to lower the refractive index of the coating film and to impart water repellency, the presence of a fluorine atom in the molecule is preferred. In the present invention, a combination of a polymer, which contains a fluorine atom, has a number average molecular weight of not less than 20000 and is curable upon exposure to an ionizing radiation, with fluorine-containing and/or fluorine-free monomers which contain two or more ionizing radiation curable functional groups per molecule is preferred. The composition using this combination comprises a monomer and/or a polymer containing an ionizing radiation curing-type fluorine atom as a binder for imparting a film forming property (a film forming capability) and a low refractive index to the low-refractive index composition.

The monomer and/or oligomer containing and/or free from a fluorine atom in its molecule has the effect of enhancing the crosslinking density of the coating film, is a component having high fluidity due to its small molecular weight, and the effect of improving the coatability of the coating composition.

The fluorine atom-containing polymer has a satisfactorily large molecular weight and thus has a higher level of film forming property than the monomer and/or oligomer containing and/or free from a fluorine atom. A combination of this fluorine atom-containing polymer with the monomer and/or oligomer containing and/or free from a fluorine atom can improve the fluidity to improve suitability as the coating liquid and further can enhance the crosslinking density to improve the hardness or strength of the coating film.

Specific examples of fluorine atom-containing monomers Include fluoroolefins (for example, fluoroethylene, vinylidene fluoride, tetrafluoroethylene, hexafluoropropylene, perfluorobutadiene, perfluoro 2,2-dimethyl-1,3-dioxole), partially or fully fluorinated alkyl, alkenyl, or alryl esters of acrylic or methacrylic acid (for example, compounds represented by formula (III) or (IV):

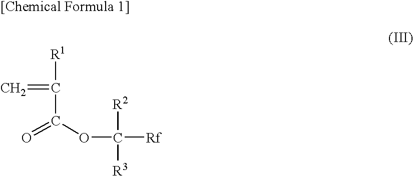

wherein
R¹ represents a hydrogen atom, an alkyl group having 1 to 3 carbon atoms, or a halogen atom,
R² and R³ each independently represent a hydrogen atom, an alkyl group, an alkenyl group, a hetero ring, an aryl group, or a group defined by Rf,
Rf represents a fully or partially fluorinated alkyl group, alkenyl group, hetero ring, or aryl group,
R¹, R², R³, and Rf each may have a substituent other than a fluorine atom, and
two or more of R²a R³ and Rf together may combine to form a cyclic structure, or

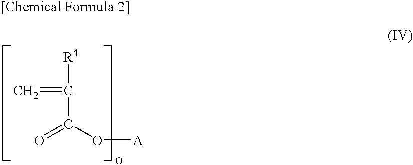

wherein
A represents a fully or partially fluorinated organic group having a valency of n,
R⁴ represents a hydrogen atom, an alkyl group having 1 to 3 carbon atoms, or a halogen atom, and R⁴ may have a substituent other than a fluorine atom, and
o is an integer of 2 to 8, fully or partially fluorinated vinyl ethers, fully or partially fluorinated vinyl esters, and fully or partially fluorinated vinyl ketones.

Specific examples of fluorine atom-free monomers Include pentaerythritol triacrylate; diacrylates such as ethylene glycol diacrylate and pentaerythritol diacrylate monostearate; trlmeth)acrylates such as trimethylolpropane triacrylate and pentaerythritol triacrylate; polyfunctional (meth)acrylates such as pentaerythritol tetraacrylate derivatives and dipentaerythritol pentaacrylate; or oligomers produced by polymerizing these radical polymernzable monomers. These fluorine-free monomers and/or oligomers may be used in a combination of two or more.

A composition comprising a combination of a fluorine atom-containing polymer containing mutually polymerizable functional groups with a fluorine atom-containing and/or fluorine atom-free monomer is preferred, because the fluorine atom-containing polymer can improve the film forming property of the coating composition, the fluorine atom-containing and/or fluorine atom-free monomer can enhance the crosslinking density and can improve the coatability, and, by virtue of the balance between both the components, excellent hardness and strength can be imparted to the coating film. In this case, the use of a combination of a fluorine atom-containing polymer having a number average molecular weight of 20,000 to 500,000 with a fluorine atom-containing and/or fluorine atom-free monomer having a number average molecular weight of not more than 20,000 is preferred, because various properties including coatability, film forming properties, film hardness, and film strength can easily be regulated.

The polymer containing fluorine in its molecule may be a homopolymer or copolymer of one or at least two fluorine atom-containing monomers properly selected from the above fluorine atom-containing monomers, or a copolymer of one or at least two fluorine atom-containing monomers with one or at least two fluorine-free monomers, specific examples thereof Include polytetrafluoroethylene/1,4-fluoroethylene-6-fluoropropylene copolymers, 4-fluoroethylene/perfluoroalkyl vinyl ether copolymers, 4-fluoroethylene/ethylene copolymers, polyvinyl fluoride, polyvinylidene fluoride, (co)polymers of partially and fully fluorinated alkyl, alkenyl, or aryl esters of acrylic or methacrylic acid (for example, compounds represented by formula (III) or (IV)), fluoroethylene/hydrocarbon-type vinyl ether copolymers, and fluorine-modified products of epoxy, polyurethane, cellulose, phenol, polyimide, silicone or other resins. A commercially available product Cytop (tradename: manufactured by Asahi Glass Co., Ltd.) may be mentioned as other example thereof.

In this connection, in the present invention, polyvinylidene fluoride derivatives represented by formula (V) are particularly preferred because of their low refractive index, easy introduction of a curable functional group, and excellent compatibility with other binders and void-containing fine particles:

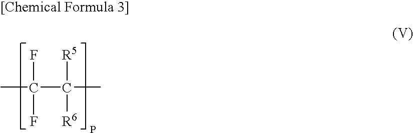

wherein
R⁵ represents a hydrogen atom, an alkyl group having 1 to 3 carbon atoms, or a halogen atom,
R⁶ represents a fully or partially fluorinated vinyl, (meth)acrylate, epoxy, oxetane, aryl, maleimide, hydroxyl, carboxyl, amino, amide, or alkoxy group through a directly or fully or partially fluorinated alkyl, alkenyl, ester, or ether chain, and
p is 100 to 100000.

Specific examples of polyvinylidene fluoride derivatives represented by formula (V) include pentaerythritol triacrylate; diacrylates such as ethylene glycol diacrylate and pentaerythritol diacrylate monostearate, tri(meth)acrylates such as trimethylolpropane triacrylate and pentaerythritol triacrylate; polyfunctional (meth)acrylates such as pentaerythritol tetraacrylate derivatives and dipentaerythritol pentaacrylate; or oligomers produced by polymerizing these radical polymerizable monomers. These fluorine-free monomers and/or oligomers may be used in a combination of two or more.

Various properties such as film forming properties, coatability, the crosslinking density of the ionizing radiation curing, the fluorine atom content, and the content of heat curable polar group can be regulated by properly combining monomers, oligomers, or polymers belonging to the binder components, with monomers, oligomers, or polymers not belonging to the hinder components. For example, the crosslinking density and processablilty are improved by monomers and oligomers, and the film forming property of the coating composition is improved by the polymers.

In the present invention, various properties of the coating film can easily be regulated by properly combining a monomer having a number average molecular weight of not more than 20,000 (a number average molecular weight as measured by GPC using polystyrene as a standard substance) and a polymer having a number average molecular weight of not less than 20,000 selected from the binder components.

Optional Components

The low-refractive index layer comprises hydrophobitized fine particles and a binder. If necessary, the low-refractive index layer may further comprise, for example, a fluorocompound and/or a silicon compound, and a binder other than the ionizing radiation curing resin composition containing a fluorine atom in its molecule. Further, solvents, polymerization initiators, curing agents, crosslinking agents, ultraviolet light shielding agents, ultraviolet absorbers, surface conditioning agents (leveling agents) or other components may be contained in the coating liquid for low-refractive index layer formation,

1) Fluorocompound and/or Silicon Compound

The low-refractive index layer may contain and rather preferably contains a fluorocompound and/or a silicon compound that are compatible with any of the ionizing radiation curing resin composition containing a fluorine atom in its molecule and the fine particles. Flattening the surface of the coating film used on the outermost surface and imparting slipperiness, which is effective for improving antifouling properties and scratch resistance necessary for the antireflective laminate, can be realized by incorporating the fluorocompound and/or the silicon compound.

Further, in the present invention, preferably, at least a part of the fluorocompound and/or the silicon compound is fixed to the outermost surface of the coating film as a result of the formation of a covalent bond by a chemical reaction with the ionizing radiation curing resin composition, whereby the slipperiness effective for improving the antifouling properties or scratch resistance necessary after the commercialization of the antireflective laminate can be stably maintained for a long period of time.

Specific examples of preferred fluorocompounds include compounds containing
a perfluoroalkyl group represented by formula C_{d}F_{2d+1} wherein d is preferably an integer of 1 or 2,
a perfluoroalkylene group represented by formula —(CF₂CF₂)_{g} wherein g is preferably an integer of 1 to 50,
a perfluoroalkyl ether group represented by formula F—(—CF(CF₃)CF₂O—)ₑ—CF(CF₃) wherein e is preferably an integer of 1 to 50, or
a perfluoroalkenyl group exemplified by formula CF₂═CFCF₂CF₂—, formula (CF₈)₂C═C(C₂F₈)—, or formula ((CF₃)₂CF)₂C═C(CF₃)—, or mixtures of these fluorocompounds.

The structure of the fluorocompound is not particularly limited so far as the above functional group is contained. For example, polymers of fluorine-containing monomers or copolymers of fluorine-containing monomers with fluorine-free monomers may also be used. Among them, a block copolymer or a graft copolymer comprising a fluoropolymer segment, comprising either a homocopolymer of a fluorine-containing monomer, or a copolymer of a fluorine-containing monomer with a fluorine-free monomer, and a fluorine-free polymer segment is particularly preferred.

In the copolymer, the fluorine-containing polymer segment mainly has the function of enhancing antifouling properties and water-repellent/oil-repellent properties, while the fluorine-free polymer segment has high compatibility with the binder and thus has an anchor function. Accordingly, the antireflective laminate using the copolymer is advantageous in that, even when the surface is repeatedly rubbed, the separation of the fluorocompound is prevented and various properties such as antifouling properties can be maintained for a long period of time.

The fluorocompound may be a commercially available product, and preferred examples thereof include Modiper F Series (tradename) manufactured by Nippon Oils & Fats Co., Ltd., Defensa MCF Series (tradename) manufactured by Dainippon Ink and Chemicals, Inc.

The fluorocompound or/and the silicon compound preferably has a structure represented by formula (I):

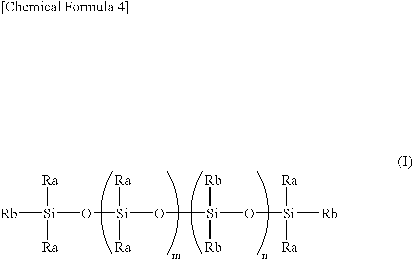

wherein
Ra represents an alkyl group having 1 to 20 carbon atoms,
Rb represents an unsubstituted alkyl group having 1 to 20 carbon atoms, or an amino, epoxy, carboxyl, hydroxyl, perfluoroalkyl, perfluoroalkylene or perfluoroalkyl ether group, or an (meth) acryloyl group-substituted alkyl group having 1 to 20 carbon atoms, an alkoxy group having 1 to 3 carbon atoms, or a polyether-modified group,
Ra and Rb may be the same or different,
m is an integer of 0 to 200, and
n is an Integer of 0 to 200.

The polydimethylsilicone having a basic skeleton represented by formula (I) is generally known to have low surface tension and have excellent water repellency or releasability. A further effect can be imparted by introducing various functional groups into the side chain or end. For example, the reactivity can be imparted by introducing an amino, epoxy, carboxyl, hydroxyl, (meth)acryloyl, alkoxy or other group, and a covalent bond can be formed by a chemical reaction with the ionizing radiation curing resin composition containing a fluorine atom in its molecule. Further, for example, oil resistance or lubricity can be imparted by introducing a perfluoroalkyl, perfluoroalkylene, perfluoroalkyl ether group. Furthermore, leveling properties or lubricity can be improved by introducing a polyether modification group.

Such compounds are commercially available, and examples thereof Include fluoroalkyl group-containing silicone oil FL100 (tradename: manufactured by The Shin-Etsu Chemical Co., Ltd.), and polyether-modified silicone oil TSF4460 (tradename, manufactured by GE Toshiba Silicone Co., Ltd.). Various modified silicone oils are available according to the purpose.

In a preferred embodiment of the present invention, the fluoro orland silicon compound has a structure represented by formula (II):

RcₖSIX₄₋ₖ (II)

wherein
Rc represents a hydrocarbon group having 3 to 1000 carbon atoms and containing a perfluoroalkyl, perfluoroalkylene, or perfluoroalkyl ether group,
X's, which may be the same or different, represent a hydrolyzable group, for example, an alkoxy group having 1 to 3 carbon atoms (for example, a methoxy, ethoxy, or propoxy group), an oxyalkoxy group such as a methoxymethoxy or methoxyethoxy group, or a halogen group (for example, a chloro, bromo, or iodo group), and
k is an integer of 1 to 3.

The presence of the hydrolyzable group has the effect that, particularly when fine particles as the inorganic component are used, the hydrolyzable group, together with hydroxyl groups on the surface of the fine particles, is likely to form a covalent bond or a hydrogen bond and, consequently, the adhesion can be maintained. Compounds having this structure include fluoroalkylsilanes. For example, TSL8257 (tradename: manufactured by GE Toshiba Silicone Co., Ltd.) may be mentioned as a commercially available product.

The content of the fluorocompound and/or the silicon compound is preferably in the range of 0.01 to 10% by weight, preferably 0.1 to 3.0% by weight, based on the total weight of the ionizing radiation curing resin composition containing a fluorine atom in its molecule and the fine particles. When the content is in the above-defined range, satisfactory antifouling properties and lubricity can be imparted to the antireflective laminate and, at the same time, the strength of the coating film can be rendered satisfactory.

The fluorocompounds and/or the silicon compounds may be used solely or as a mixture of two or more. Various properties such as antifouling properties, water-repellency/oil-repellency, lubricity, scratch resistance, and durability can be regulated by properly selecting and using these compounds, whereby contemplated functions can be developed.

2) Polymerization Initiator

The polymerization initiator may be properly added according to the reaction form of the binder component and the fine particles, for example, when the binder composed mainly of fluorine atom-containing component, the fine particles to which ionizing radiation curing properties have been imparted, and the ionizing radiation curable group as other binder component (optional component) are less likely to directly cause a polymerization reaction upon exposure to an ionizing radiation.

For example, when the ionizing radiation curable group in the binder composed mainly of a fluorine atom-containing component is an ethylenically unsaturated bond, a photoradical polymerization initiator is used.

Specific examples of photoradical polymerization initiators include acetophenones, benzophenones, ketals, anthraqulnones, thioxanthones, azo compounds, peroxides, is 2,3-dialkyidione compounds, disulfide compounds, thlurarm compounds, and fluoroamine compounds. More specific examples thereof include 1-hydroxy-cyclohexyl-phenyl-ketone, 2-methyl-1-[4-(methylthio)phenyl]-2-morpholinopropan-1-one, benzyl dimethyl ketone, 1-(4-dodecylphenyl)-2-hydroxy-2-methylpropan -1-one, 2-hydroxy-2-methyl-1-phenylpropan-1-one, 1-(4-isopropylphenyl)-2-hydroxy-2-methylpropan-1-one, and benzophanone. Preferred are 1-hydroxy-cyclohexyl-phenyl-ketone and 2-methyl-1-[4-(methylthio)phenyl]-2-morpholinopropan-1-one. These compounds are preferred, because they, even when used in a small amount, can function to accelerate the initiation of the polymerization reaction upon exposure to an ionizing radiation.

They may be used either solely or in a combination of two or more. The above compounds may be commercially available products. For example, 1-hydroxy-cyclahexyl-phenyl-ketone is available as Irgacure-184 (tradename: Ciba Specialty Chemicals, K.K.).

The photoradical polymerization initiator is incorporated in an amount of 3 to 15 parts by weight based on the total weight (100 parts by weight) of the binder composed mainly of a fluorine atom-containing component.

3) Curing Agent

The curing agent may be incorporated for accelerating a heat curing reaction of a heat curable polar group in the binder composed mainly of a fluorine atom-containing component. When the heat curable polar group is a hydroxyl group, curing agents usable herein include basic group-containing compounds such as methylol melamine, and compounds containing a hydrolyzable group that generates a hydroxyl group upon hydrolysis, for example, metal alkoxides. Preferred “basic groups” include amine, nitrile, amide, and isocyanate groups. The “hydrolyzable group” is preferably an alkoxy group.

When the heat curable polar group in the binder composed mainly of a fluorine atom-containing component is an epoxy group, polycarboxylic acid anhydrides or polycarboxylic acids are generally used as the curing agent in the coating composition. Specific examples of polycarboxylic acid anhydrides include aliphatic or alicyclic dicarboxylic anhydrides, for example, phthalic anhydride, itaconic anhydride, succinic anhydride, citraconic anhydride, dodecenylsuccinic anhydride, tricarballylic anhydride, maleic anhydride, hexahydrophthalic anhydride, dimethyltetrahydrophthalic anhydride, hymic anhydride, and nadinic anhydride, aliphatic polycarboxylic dianhyrides, for example, 1,2,3,4-butanetetracarboxylic dianhydride and cyclopentanetetracarboxylic acid dianhydride; aromatic polycarboxylic anhydrides, for example, pyromellitic anhydride, trimellitic anhydride, and benzophenonetetracarboxylic anhydride; and ester group-containing acid anhydrides, for example, ethylene glycol bistrimellitate and glycerin tristrimellitate. Preferred are aromatic polycarboxylic anhydrides. Epoxy resin curing agents formed of commercially available carboxylic anhydrides are also suitable.

Specific examples of polycarboxylic acids used In the present invention include aliphatic polycarboxylic acids such as succinic acid, glutaric acid, adipic acid, butanetetracarboxylic acid, maleic acid, and itaconic acid; aliphatic polycarboxylic acids such as hexahydrophthalic acid, 1,2-cyclohexanedicarboxylic acid, 1,2,4-cyclohexanetricarboxylic acid, and cyclopentanetetracarboxylic acid, and aromatic polycarboxylic acids such as phthalic acid, isophthalic acid, terephthalatic acid, pyromellitic acid, trimellitic acid, 1,4,5,8-naphthalenetetracarboxylic acid, and benzophenonetetracarboxylic acid. Preferred are aromatic polycarboxylic acids. The curing agent may be used in an amount of 0.05 to 30.0 parts by weight based on the total weight (100 parts by weight) of the binder composed mainly of the fluorine atom-containing component.

Properties of Low-Refractive Index Layer

1) Contact Angle with Water

In a preferred embodiment of the present invention, the low-refractive index layer has a contact angle with water of not less than 90°, preferably not less than 100°. When the contact angle with water is this value, the water resistance, alkali resistance, and wetting resistance can be realized and, consequently, the mechanical properties of the low-refractive index layer can be maintained for a long period of time. The larger the contact angle with water, the less the susceptibility of the surface of the coating film to water, that is, the less the impregnation of a water-containing alkali or the like into the coating film. Specifically, the contact angle was measured with JIS R 3257: 1999 “Testing method of wettability of glass substrate” with microscopic contact angle goniometer CA-QI series manufactured by Kyowa Interface Science Co., Ltd.

2) Refractive Index

The low-refractive index layer has a refractive index of not more than 1.45, preferably not more than 1.42.

3) Mean Roughness

In a planar area of 5 μm² in the outermost surface of the low-refractive index layer,
the ten-point mean roughness (Rz) is not more than 100 nm, preferably not more than 80 nm, and
the arithmetical mean roughness (Ra) is not less than 1 nm and not more than 30 nm, and, preferably, the lower limit of the arithmetical mean roughness (Ra) is not less than 2 nm while the upper limit is not more than 25 nm.

The mean roughness is measured by a method that measures the surface shape as a two-dimensional or three-dimensional profile. Since it is difficult to objectively compare the curve per se, various roughness indexes are calculated from the profile curve data.

The ten-point mean roughness (Rz) is the sum of the mean of the five largest deviation values among deviation values from the mean value and the mean of absolute values of the five smallest deviation values. The arithmetical mean roughness (Ra) is the mean value of absolute values of deviations from the arithmetic mean value.

The roughness is actually measured under a scanning probe microscope or an atomic force microscope.

4) The water resistance can be evaluated by measuring the difference in reflectance using a testing black tea liquid according to the testing method specified in JIS K 6902.

2. Light-Transparent Base Material

The light-transparent base material may be transparent, semi-transparent, colorless or chromatic so far as it is transparent to light. Preferably, however, the light-transparent base material is colorless and transparent. Specific examples of light-transparent base materials include glass plates, or thin films formed, for example, by cellulose triacetate (TAC), polyethylene terephthalate (PET), diacetyl cellulose, cellulose acetate butylate, polyethersulfone, or acrylic resin; polyurethane resin; polyester; polycarbonate; polysulfone; polyether; trimethylpentene; polyether ketone; or (meth)acrylonitrile.

The thickness of the light-transparent base material is about 30 μm to 200 μm, preferably 50 μm to 200 μm.

3. Optional Layer

The antireflective laminate according to the present invention comprises at least a light-transparent base material and a low-refractive index layer. Any optional layer may be further provided.

Hardcoat Layer

The hardcoat layer may be formed for improving scratch resistance, strength and other properties of the antireflective laminate. The term “hardcoat layer” refers to a layer having a hardness of “H” or higher in a pencil hardness test specified In JIS 5600-5-4:1999. The hardcoat layer is preferably formed by using an ionizing radiation curing resin composition, more preferably a composition containing components having an (meth)acrylate-type functional group, for example, relatively low-molecular weight polyester resins, polyether resins, acrylic resins, epoxy resins, urethane resins, alkyd resins, spiroacetal resins, polybutadiene resins, polythiol polyether resins, polyhydric alcohols, ethylene glycol di(meth)acrylate, and pentaerythritol di(meth)acrylate monostearate or other di(meth)acrylates; trimethylolpropane tri(meth)acrylate, pentaerythritol tri(meth)acrylate, or other tri(meth)acrylates, pentaerythritol tetra(meth)acrylate derivatives, dipentaerythritol penta(meth)acrylate, or other polyfunctional compound monomers, or epoxy acrylate or urethane acrylate or other oligomers.

The thickness of the hardcoat layer (on a cured state basis) is preferably in the range of 0.1 to 100 μm, more preferably in the range of 0.8 to 20 μm. When the layer thickness is in the above-defined range, the function as the hardcoat layer is satisfactory. When the hardcoat layer is formed so as to have a refractive index of 1.57 to 1.70, this hardcoat layer per se functions also as other refractive index layer, that is, a medium-refractive index layer or a high-refractive index layer, and, thus, the antireflection properties can be further improved.

In a more preferred embodiment of the present invention, the hardcoat layer is formed as follows.

Resin

The resin is preferably transparent, and specific examples thereof include three types of resins, that is, ionizing radiation curing resins curable upon exposure to ultraviolet light or electron beams, mixtures of ionizing radiation curing resins with solvent drying-type resins, and heat curing resins. Preferred are ionizing radiation curing resins.

Specific examples of ionizing radiation curing resins include acrylate functional group-containing resins, for example, relatively low-molecular weight polyester resins, polyether resins, acrylic resins, epoxy resins, urethane resins, alkyd resins, spiroacetal resins, polybutadiene resins, polythlolpolyene resins, oligomers or prepolymers of (meth)acrylates or the like of polyfunctional compounds such as polyhydric alcohols, and reactive diluents. Specific examples thereof include monofunctional monomers and polyfunctional monomers Such as ethyl (meth)acrylate, ethylhexyl (meth)acrylate, styrene, methylstyrene, N-vinylpyrrolidone, for example, polymethylolpropane tri(meth)acrylate, hexanediol (meth)acrylate, tri propylene glycol di(meth)acrylate, diethylene glycol di(meth)acrylate, pentaerithritol tri(math)acrylate, dipentaerithritol hexa(meth)acrylate, 1,6-hexanediol di(meth)acrylate, and neopentyl glycol di(meth)acrylate.

When an ionizing radiation curing resin is used as the ultraviolet curing resin, the use of a photopolymerization initiator is preferred. Specific examples of photopolymerization initiators include acetophenones, benzophenones, Michler's benzoyl benzoate, α-amyloxime ester, tetramethylthiuram monosulfide, and thioxanthones. Further, a photosensitizer is preferably mixed in the resin, and specific examples thereof include n-butylamine, triethylamine, and poly-n-butylphosphine.

The solvent drying-type resin used as a mixture with the ionizing radiation curing resin is mainly a thermoplastic resin. Generally exemplified thermoplastic resins may be used. The occurrence or coating film defects in the coating surface can be effectively prevented by adding the solvent drying-type resin. in a preferred embodiment of the present invention, when the material for the transparent base material is a cellulosic resin such as TAC, specific examples of preferred thermoplastic resins include cellulosic resins, for example, nitrocellulose resins, acetyl cellulose resins, cellulose acetate propionate resins, and ethyl hydroxyethylcellulose resins.

Specific examples of heat curing resins include phenolic resins, urea resins, diallyl phthalate resins, melanin resins, guanamine resins, unsaturated polyester resins, polyurethane resins, epoxy resins, aminoalkyd resins, melamine-urea co-condensation resins, silicone resins, and polysiloxane resins. When heat curing resins are used, if necessary, curing agents such as crosslinking agents and polymerization initiators, polymerization accelerators, solvents, viscosity modifiers and the like may also be added.

Solvent

In forming the hardcoat layer, a composition for a hardcoat layer which is a mixture of the above components with a solvent is utilized. Specific examples of solvents include: alcohols such as Isopropyl alcohol, methanol, and ethanol; ketones such as methyl ethyl ketone, methyl isobutyl ketone, and cyclohexanone; esters such as ethyl acetate and butyl acetate; halogenated hydrocarbons; aromatic hydrocarbons such as toluene and xylene; or mixtures thereof. Preferred are ketones and esters.

Optional Components

1) Polymerization Initiator

A photopolymerization initiator may be used in forming a hardcoat layer. Specific examples thereof include 1-hydroxy-cyclohexyl-phenyl-ketone. This compound is commercially available, for example, under the tradename Irgacure 184 (manufactured by Ciba Specialty Chemicals, K.K.). The hardcoat layer may comprise an antistatic agent (electrically conductive agent) and/or an anti-dazzling agent. The antistatic agent and the anti-dazzling agent may be the same as those which will be described later.

2) Antistatic Agent and/or Anti-Dazzling Agent

The hardcoat layer preferably comprises an antistatic agent and/or an anti-dazzling agent. The antistatic agent and the anti-dazzling agent may be the same as that described in connection with an antistatic layer and an anti-dazzling layer which will be described later.

Formation of Hardcoat Layer

The hardcoat layer may be formed by mixing the above-described resin, solvent and optional components together to prepare a composition which is then coated onto a light transparent base material. In a preferred embodiment of the present invention, a leveling agent such as a fluoro or silicone leveling agent is added to the liquid composition. The liquid composition with a leveling agent added thereto can effectively prevent the inhibition of curing by oxygen on the coating film surface at the time of coating or drying and can impart scratch resistance.

The composition may be coated by a coating method such as roll coating, Mayer bar coating, or gravure coating. After coating or the liquid composition, drying and ultraviolet curing are carried out. Specific examples of ultraviolet light sources include ultrahigh pressure mercury lamps, high pressure mercury lamps, low pressure mercury lamps, carbon arc lamps, black light fluorescent lamps, and metal halide lamps, A wavelength region of 190 to 380 nm may be used as wavelengths of the ultraviolet light. Specific examples of electron beam sources include various electron beam accelerators, such as Cockcroft-Walton accelerators, van de Graaff accelerators, resonance transformers, insulated core transformers, linear, dynamitron, and high-frequency electron accelerators.

2) Antistatic Layer

The antistatic layer may be provided in the antireflective laminate from the viewpoints of suppressing the occurrence of static electricity, the elimination of dust adhesion, and the suppression of external electrostatic troubles. The antistatic layer preferably has the function of playing a role for bringing the surface resistivity of the antireflective laminate to not more than 10¹² Ω/□. However, even when the surface resistivity Is not less than 10¹² Ω/□, preferably, the antistatic layer is provided so far as the above various functions such as the suppression of the occurrence of static electricity can be developed.

Specific examples of antistatic agents usable for antistatic layer formation include quaternary ammonium salts, pyridinium salts, various cationic compounds containing cationic groups such as primary to tertiary amino groups, anionic compounds containing anionic groups such as sulfonic acid bases, sulfuric ester bases, phosphoric ester bases, and phosphonic acid bases, amphoteric compounds such as amino acid and aminosulfuric acid ester compounds, nonionic compounds such as amino alcohol, glycerin, and polyethylene glycol compounds, organometal compounds such as alkoxides of tin and titanium, and metal chelate compounds such as their acetyl acetonate salts. Further, compounds prepared by increasing the molecular weight of the above exemplified compounds may also be mentioned. Furthermore, monomers or oligomers, which contain a tertiary amino group, a quaternary ammonium group, or a metal chelate part and is polymerizable by an ionizing radiation, or polymerizable compounds, for example, organometal compounds such as coupling agents containing a functional group(s) polymerizable by an ionizing radiation may also be used as the antistatic agent.

Further, ultrafine particles having a particle diameter of not more than 100 nm, for example, tin oxide, tin-doped indium oxide (ITO), antimony-doped tin oxide (ATO), Indium-doped zinc oxide (AZO), antimony oxide, and indium oxide, may also be used as the antistatic agent. The particle diameter of such compounds have a particle diameter which is not more than the wavelength of visible light, that is, a particle diameter of not more than 100 nm. Accordingly, the formed antistatic layer is transparent and is not detrimental to the properties of the antireflective laminate.

In another embodiment of the present invention, an antistatic agent may be added to the hardcoat layer, an anti-dazzling layer which will be described later, and other refractive index layer to impart an antistatic capability to these layers.

3) Anti-dazzling Layer

The anti-dazzling layer may be provided between the transparent base material and the hardcoat layer or the low-refractive index layer. The anti-dazzling layer may be formed of an ionizing radiation curing resin composition and fine particles. The ionizing radiation curing resin composition may be properly selected from those described above in connection with the hardcoat layer. The fine particles may be either an inorganic type or an organic type but are preferably resin beads.

In a more preferred embodiment of the present invention, the anti-dazzling layer may be formed as follows. The anti-dazzling layer preferably satisfies all the following formulae simultaneously:

8R≦Sm≦30R

R<Hmax<3R

1.3≦θa≦2.5

1≦R≦8

wherein R represents the average particle diameter of the fine particles, μm; Hmax represents the maximum value of the distance of the profile peak in profile irregularities from the base material surface in the vertical direction, μm; Sm represents the mean spacing of profile irregularities, μm; and θa represents the average angle of inclination in the profile irregularities.

In still another preferred embodiment of the present invention, the anti-dazzling layer satisfies Δn=|n1−n2|<0.1 wherein n1 represents the refractive index of the fine articles and n2 represents the refractive index of the transparent resin composition, and the haze value within the anti-dazzling layer is not more than 55%.

Anti-Dazzling Agent

Fine particles may be mentioned as the anti-dazzling agent and may be in the form of sphere, ellipse and the like, preferably sphere. The fine particles may be either inorganic or organic type. The fine particles are preferably formed of an organic material. The fine particles exhibit anti-dazzling properties and are preferably transparent. Specific examples of fine particles include plastic beads, more preferably transparent plastic beads. Specific examples of plastic beads include styrene beads (refractive index 1.59), melamine beads (refractive index 1.57), acrylic beads (refractive index 1.49), acrylic-styrene beads (refractive index 1.54), polycarbonate beads, polyethylene beads and the like. The amount of the fine particles added is 2 to 30 parts by weight, preferably about 10 to 25 parts by weight, based on 100 parts by weight of the transparent resin composition,

An antisettling agent is preferably added in the preparation of the composition for an anti-dazzling layer, because the addition of the antisettling agent can suppress the precipitation of the resin beads and consequently can homogeneously disperse the resin beads in the solvent. Specific examples of antisettling agents usable herein include silica beads having a particle diameter of not more than 0.5 μm, preferably about 0.1 to 0.25 μm.

The thickness of the anti-dazzling layer (cured state) is preferably 0.1 to 100 μm, preferably 0.8 to 10 μm. When the layer thickness is in the above-defined range, the functions as the anti-dazzling layer can be satisfactorily developed.

4) Other Refractive Index Layers (High-Refractive Index Layer and Medium-Refractive Index Layer)

In a preferred embodiment of the present invention, other refractive index layers (a high-refractive index layer and a medium-refractive index layer) may be provided to further improve the antireflection properties. Preferably, these layers may be provided between the hardcoat layer and the low-refractive index layer. The refractive index of these refractive index layers may be set to a range of 1.46 to 2.00. Further, in the present invention, the medium-refractive index layer refers to a layer having a refractive index in the range of 1.46 to 1.80. The high refractive index layer refers to a layer having a refractive index in the range of 1.65 to 2.00.

These refractive index layers may be formed of an ionizing radiation curing resin and ultrafine particles having a particle diameter of not more than 100 nm and a predetermined refractive index. Specific examples of such fine particles (the value within the parentheses representing the refractive index) include zinc oxide (1.90), titania (2.3 to 2.7), ceria (1.95), tin-doped indium oxide (1.95), antimony-doped tin oxide (180), yttria (1.87), and zirconia (2.0).

The refractive index of the ultrafine particles is preferably higher than that of the ionizing radiation curing resin. In general, the refractive index of the refractive index layer is determined by the content of the ultrafine particles. Therefore, the larger the amount of the ultrafine particles added, the higher the refractive index of the refractive index layer. For this reason, the refractive index was brought to a range of 1.46 to 1.80 by regulating the addition ratio of the ionizing radiation curing resin and the ultrafine particles. The formation of the higher-refractive index layer or the medium-refractive index layer is possible.

When the ultrafine particles are electrically conductive, other refractive index layer (a high-refractive index layer or a medium-refractive index layer) formed of such ultrafine particles has antistatic properties.

The high-refractive index layer or medium-refractive index layer may be in the form of a vapor-deposited film of an inorganic oxide having a high refractive index such as titanium oxide or zirconium oxide formed by vapor deposition such as chemical vapor deposition CVD) or physical vapor deposition (PVD), or alternatively may e in the form of a coating film with inorganic oxide fine articles having a high refractive index such as titanium oxide ispersed therein.

Anti-Fouling Layer

In a preferred embodiment of the present invention, n anti-fouling layer may be provided for preventing fouling of he outermost surface of the low-refractive index layer. Preferably, the anti-fouling layer is provided on the surface of the light transparent base material remote from the low-refractive index layer. The anti-fouling layer can further improve anti-fouling properties and scratch resistance of the antireflective laminate.

Specific examples of agents for the anti-fouling layer include fluorocompounds and/or silicon compounds, which have low compatibility with an ionizing radiation curing resin composition having a fluorine atom in its molecule and cannot be incorporated into the low-refractive index layer without difficulties, and fluorocompounds and/or silicon compounds which are compatible with an ionizing radiation curing resin composition having a fluorine atom in its molecule and fine particles.

Production Process of Antireflective Laminate Formation of Low-Refractive Index Layer

In order to form the low-refractive index layer on a light-transparent base material or the outermost surface of any desired layer, a coating liquid for a low-refractive index layer is prepared.

Preparation of Coating Liquid

The coating liquid may be prepared by mixing and dispersing fine particles, a binder, and other components according to a conventional preparation method. The mixing and dispersion can be properly carried out, for example, by a paint shaker or a bead mill.

Solvent

A solvent may if necessary be used in the preparation of a coating liquid for a low-refractive index layer from the viewpoints of dissolving and dispersing solid components, regulating the concentration, and improving the coatability. The solvent is not particularly limited, and various organic solvents can be used. Specific examples of such organic solvents include: alcohols such as isopropyl alcohol, methanol, and ethanol; ketones such as methyl ethyl ketone, methyl isobutyl ketone, and cyclohexanone; esters such as methyl acetate, ethyl acetate and butyl acetate; halogenated hydrocarbons; aromatic hydrocarbons such as toluene and xylene; or mixtures thereof. Preferred are ketones.

When a coating liquid prepared using ketones is used, the coating liquid can easily be coated onto the substrate surface thinly and evenly. At the same time, the evaporation rate of the solvent after coating is proper and can effectively suppress uneven drying and the like, and can easily form an evenly thin large-area coating film, in particular, when a refractive index layer is coated after coating an anti-dazzling layer or an anti-dazzling agent onto the hardcoat layer, the preparation of a coating liquid using a ketone solvent can realize even coating an the surface having fine concaves and convexes, whereby uneven coating can be prevented.

A single solvent composed of one ketone, a mixed solvent composed of two or more ketones, and a solvent, containing one or at least two ketones and additionally other solvent(s), which does not lose properties as the ketone solvent may be used as the ketone solvent. A ketone solvent, in which not less than 70% by weight, particularly not less than 80% by weight, of the solvent is accounted for by one or at least two ketones, is preferred. The amount of the solvent is properly regulated so that the solvent can dissolve and disperse each component homogeneously, the prepared dispersion does not cause agglomeration during storage, and the coating liquid is not excessively thin at the time of coating. In this connection, a method is preferably adopted in which the amount of the solvent used is reduced in such an amount range that can satisfy the above requirements, to prepare a coating liquid for low-refractive index layer formation by high-concentration coating, the high-concentration coating liquid is stored in such a state that no large capacity is required, and, in use, a necessary amount of the high-concentration coating liquid is taken out and is diluted to a concentration suitable for coating work.

A coating liquid for a low-refractive index layer, which is particularly excellent in dispersion stability and is suitable for long-term storage, can be prepared by using, based on 100 parts by weight in total of the solid matter and the solvent, 0.5 to 50 parts by weight in total of the solid matter and 50 to 95.5 parts by weight of the solvent, more preferably 10 to 30 parts by weight in total of the solid matter and 70 to 90 parts by weight of the solvent.

Coating

The coating liquid for a low-refractive index layer is coated onto the light-transparent base material or the outermost surface of any optional layer. Specific examples of coating method usable herein include various methods such as spin coating, dip coating, spraying, slide coating, bar coating, roll coating, meniscus coating, flexographic printing, screen printing, and bead coating.

Formation of Optional Layers

In the antireflective laminate, in addition to the light-transparent base material and the low-refractive index layer, optional layers may be formed. In this case, the optional layers can be formed by preparing a coating liquid for each layer and coating the coating liquid in the same manner as in the formation of the low-refractive index layer.

### EXAMPLES

The contents of the present invention will be described in more detail with reference to the following Examples that should not be construed as limiting the present invention.

1. Hydrophilization Treatment of Fine Articles

1) Treatment with Coupling Agent

An isopropyl alcohol-dispersed linear colloidal silica (IPA-ST-UP; manufactured by Nissan Chemical Industries Ltd.; solid content 15%; silica having a primary particle diameter of 9 to 15 nm has been linearly connected) was introduced into a rotary evaporator. Isopropyl alcohol as the solvent was then replaced by methyl isobutyl ketone to prepare a dispersion liquid having a silica fine particle content of 20% by weight. 3-Methacryloxypropylmethyldimethoxysilane (5 parts by weight) was added to 100 parts by weight of the methyl isobutyl ketone dispersion liquid, and the mixture was heat treated at 50° C. for one hr to prepare a methyl isobutyl ketone dispersion liquid having a hydrophobitized linear silica fine particle content of 20% by weight.

2) Polymer Grafting Treatment

Porous silica fine particles (Nipsil SS5OF: tradename, manufactured by Nippon Silica Industrial Co., Ltd., primary particle diameter 20 nm, refractive Index 1.38, specific surface area 82 m²/g) (5.0 g), 10.0 g of a polydimethylsiloxane having an OH group on its both ends (HK-20; number average molecular weight 6000; Toa Gosei Chemical Industry Co., Ltd.), and 40.0 g of methyl isobutyl ketone were placed in a stirred vessel. The mixture was shaken in a paint shaker using zirconia beads (φ; 0.3 mm) as a medium in an amount of four times the amount of the mixture for 3 hr to prepare a dispersion solution. This dispersion solution was transferred to a flask with a cooling tube, and the mixture was stirred at 100° C. for 5 hr to covalently bond a part of the reactive polymer to porous silica.

After the completion of the reaction, the reaction liquid was introduced into a centrifugal separator. The fine particles were settled, and the supernatant was removed. Methyl isobutyl ketone was again added, and the mixture was ultrasonically treated. The treatment in which the ultrafine particles are redispersed and the dispersion is centrifuged were repeated until no polymer component was observed in the supernatant after the settlement of the ultrafine particles. The solid content of the final dispersion liquid was adjusted to 20% by weight.

The silica fine particles after washing were dried in vacuo at room temperature to prepare polymer-bonded silica fine particles, The amount of the polymer bonded to the surface of the ultrafine particles was determined from the amount of the polymer which had been heat decomposed by a thermogravimetric analysis and was found to be 15% by weight

2. Preparation of Coating Liquid for Low-Refractive Index Layer

The following ingredients were mixed together to prepare a coating liquid.

Coating liquid 1

| | | |
|---|---|---|
| Fluorine atom-containing binder resin | 20 | parts by mass |
| (Opstar JM5010: tradename, manufactured | | |
| by JSR Corporation, refractive index 1.41, | | |
| solid content 10% by weight, methyl ethyl | | |
| ketone solution) | | |
| Photopolymerization initiator | 0.1 | part by mass |
| (Irgacure 907: tradename, | | |
| manufactured by Ciba Specialty | | |
| Chemicals, K.K.) | | |
| 1,1) Coupling agent-treated fine particles | 2.5 | parts by weight |
| dispersion liquid | | |
| Fluoro additive | 0.4 | part by mass |
| Modiper F3035(tradename, manufactured | | |
| by Nippon Oils & Fats Co., Ltd.; | | |
| solid content 30% by weight) | | |

Coating Liquid 2

1.2) Coating liquid 2 was prepared in the same manner as in coating liquid 1, except that a fine particle dispersion liquid subjected to polymer grafting was used.

Coating liquid 3

Coating liquid 3 was prepared in the same manner as in coating liquid 1, except that F3035 was not added.

Coating Liquid 4

Coating liquid 4 was prepared in the same manner as in coating liquid 2, except that F3035 was not added.

Coating Liquid 5

Coating liquid 5 was prepared in the same manner as in coating liquid 1, except that an isopropyl alcohol-dispersed linear colloidal silica not subjected to treatment with a coupling agent was used.

Coating Liquid 6

Coating liquid 6 was prepared in the same manner as in coating liquid 2, except that porous silica fine particles not subjected to polymer grafting treatment was used.

3. Formation of Hardcoat Layer on Light-Transoarent Base Material

The following ingredients were mixed together to prepare a coating liquid for a hardcoat layer.

Coating liquid for hardcoat layer

| | |
|---|---|
| Pentaerythritol triacrylate (PETA) | 5 parts by mass |
| Photopolymerization initiator | 0.25 part by mass |
| (Irgacure 184: tradename, | |
| manufactured by Ciba Specialty | |
| Chemicals, K.K.) | |
| Methyl isobutyl ketone | 94.75 parts by mass |

Coating

A coating liquid for a hardcoat layer was bar coated onto an 80 μm-thick trlacetate cellulose (TAC) film. The coated film was dried to remove the solvent. Ultraviolet light was then applied to the coating with an ultraviolet irradiation apparatus (Fusion UV Systems Japan KK, light source H bulb) at an exposure of 108 mJ/cm² to cure the hardcoat layer and thus to form a laminate of base material/hardcoat layer (thickness 2 μm).

4. Preparation of Antireflective Laminate

### EXAMPLE 1

A coating liquid 1 for a low-refractive index layer was bar coated onto the laminate of base material/hardcoat layer prepared in the above item 3, and the coating was dried to remove the solvent. Thereafter, the coating was exposed to ultraviolet light at an exposure of 200 mJ/cm² with an ultraviolet irradiation apparatus (Fusion UV Systems Japan KK, light source H bulb) to cure the coating film and thus to from an layer/low-refractive index layer. The layer thickness was adjusted so that the minimum value of the reflectance was at a wavelength around 550 nm.

### EXAMPLE 2

An antireflective laminate was prepared in the same manner as in Example 1, except that coating liquid 2 for a low-refractive index layer was used.

### EXAMPLE 3

An antirefleCtive laminate was prepared in the same manner as in Example if except that a coating liquid 3 for a low/refractive index layer was used. Further, a coating liquid having the following composition was coated to a thickness of 30 nm onto the outermost surface of the antireflective laminate, and the coating was heat cured at 70° C. for 4 min to form an overcoat layer and thus to prepare an antireflective laminate.

Coating liquid (for overcoat layer)

| | |
|---|---|
| Fluorine-modified silicone | 6.7 parts by weight |
| KP-801M (tradename, manufactured | |
| by The Shin-Etsu Chemical Co., Ltd.; | |
| solid content 3% by weight) | |
| Fluorine-type solvent | 93.3 parts by weight |
| FC-40 (tradename, manufactured by | |
| Sumitomo 3M Ltd.) | |

### EXAMPLE 4

An antireflective laminate was prepared in the same manner as in Example 3, except that coating liquid 4 for a low-refractive index layer was used.

### COMPARATIVE EXAMPLE 1

An antireflective laminate was prepared in the same manner as in Example 1, except that coating liquid 5 for a low-refractive index layer was used.

### COMPARATIVE EXAMPLE 2

An antireflective laminate was prepared in the same manner as in Example 1, except that coating liquid 6 for a low-refractive index layer was used.

Evaluation Test

Bemcot was immersed in a weakly alkaline cleaner [Cleaner IC-100S, manufactured by LION OFFICE PRODUCTS CORP.] and was then reciprocated by 30 times on each antireflective laminate prepared in Example 1 to Comparative Example 2 under a load of 1 kg. In this case, the following properties were measured and evaluated before and after the reciprocation and are shown in Table 1 (before the test) and Table 2 (after the test).

Evaluation 1: Measurement of Surface Roughness

For the scanning range of the outermost surface (planar region of 5 μm²) of the anti-dazzling laminate, the ten-point mean roughness (Rz) and the arithmetical mean roughness (Ra) were measured with an atomic force microscope AFM (NanoScope STM/AFM: manufactured by DIGITAL INSTRUMENTS, INC.).

Evaluation 2: Measurement of Reflectance and Transmittance

The absolute reflectance of the outermost surface of the anti-dazzling laminate was measured with a spectrophotometer (UV-3100PC) manufactured by Shimadzu Seisakusho Ltd.

Evaluation 3: Measurement of Haze

The haze value of the outermost surface of the anti-dazzling laminate was measured according to JIS K 7105: 1981 “Testing methods for optical properties of plastics.”

Evaluation 4: Adhesion Evaluation Test

The outermost surface of the anti-dazzling laminate was visually inspected for the separation of the coating film according to JIS K 5600-5-6:1999 “Testing methods for paints—Part 5: Mechanical property of film—Section 6: Adhesion test (Cross-cut test).” The results were evaluated according to the following criteria.

Evaluation Standard

Evaluation ◯: The coating film was not separated at all.

Evaluation Δ: The coating film was partially separated.

Evaluation x: The coating film was wholly separated.

Evaluation 5: Measurement of Contact Angle

The contact angle of the outermost surface of the anti-dazzling laminate was measured according to JIS R 3257:1999 “Testing method of wettability of glass substrate surface.”

Evaluation 6: Scratch Resistance Evaluation Test

The surface of the antireflective laminate was rubbed by 10 times of reciprocation with steel wool of #0000 under a predetermined frictional load (varied in 200 g increments in the range of 200 to 1000 g), and the haze value was then measured. The measured haze value was compared with the haze value of the antireflective laminate before rubbing to determine the minimum load where a change of not less than 3% was observed. The scratch resistance of the antireflective laminate was evaluated based on the results.

Evaluation 7: Water Resistance Evaluation Test for Low-Refractive Index Layer Fine Particles

The water resistance of the fine particles of the low-refractive index layer was evaluated by the following method. The results were as shown in Table 3 below.

Evaluation Method

A black tea liquid for a test was prepared according to the testing method specified in JIS K 6902. Specifically, 500 ml of water was boiled, A black tea leaf (5 g) was added thereto, and the mixture was extracted with occasional stirring for 5 min. The supernatant was used as a black tea liquid for the test.

The black tea liquid for the test (2 ml) was dropped on the surface of each of the antireflective laminates. The dropped part was covered with a watch glass. This was designated as sample 1. A sample 2 (blank) on which the black tea liquid for the test was not dropped was also provided. Each of the samples was allowed to stand for 24 hr. The dropped part of sample 1 was wiped off with ethanol or methanol, was further wiped off with dried gauze, and was then allowed to stand for one hr.

### Evaluation Method

Since no change was observed in the evaluation method specified in JIS K 6902 (a method in which standard light specified in JIS Z 8720 was applied from above the sample and the surface of the sample is visually observed), the measurement or the reflectance was carried out as a unique evaluation method, Specifically, the reflectance of samples 1 and 2 was measured, and the difference in reflectance between samples 1 and 2 was determined and was evaluated according to the following criteria.

### Evaluation Criteria

⊚: The difference In reflectance between the two samples was not less than 0.0 and less than 0.2%.

◯: The difference in reflectance between the two samples was not less than 0.3 and not more than 0.6%.

x: The difference in reflectance between the two samples was not less than 0.8%.

### [Table 1]

TABLE 1
(Before alkaline cleaner treatment)

| | Surface | | | | | |
|---|---|---|---|---|---|---|
| | roughness | Reflectance | | | Contact | Scratch |
| | Rz (nm) | transmittance | | | angle | resistance |
| | Ra (nm) | (%) | Haze | Adhesion | (°) | (g) |
| Ex. 1 | 70 | 1.2 | 0.5 | ◯ | 110 | 600 |
| | 3 | 97.8 | | | | |
| Ex. 2 | 40 | 0.9 | 0.7 | ◯ | 120 | 400 |
| | 5 | 98.3 | | | | |
| Ex. 3 | 35 | 1.2 | 0.3 | ◯ | 130 | 800 |
| | 2 | 98.0 | | | | |
| Ex. 4 | 18 | 0.9 | 0.4 | ◯ | 140 | 600 |
| | 3 | 98.5 | | | | |
| Comp. | 120 | — | 1.8 | Δ | 80 | 200 |
| Ex. 1 | 15 | 65.0 | | | | |
| Comp. | 150 | — | 2.2 | Δ | Immeasurable (*1) | 200 |
| Ex. 2 | 12 | 53.7 | | | | |

(*1) Immeasurable due to dyeing

### [Table 2]

TABLE 2
(After alkaline cleaner treatment)

| | Surface | | | | | |
|---|---|---|---|---|---|---|
| | roughness | Reflectance | | | Contact | Scratch |
| | Rz (nm) | transmittance | | | angle | resistance |
| | Ra (nm) | (%) | Haze | Adhesion | (°) | (g) |
| Ex. 1 | 60 | 1.2 | 0.5 | ◯ | 110 | 600 |
| | 3 | 97.8 | | | | |
| Ex. 2 | 30 | 0.9 | 0.7 | ◯ | 120 | 400 |
| | 5 | 98.3 | | | | |
| Ex. 3 | 30 | 1.2 | 0.3 | ◯ | 130 | 800 |
| | 2 | 98.0 | | | | |
| Ex. 4 | 15 | 0.9 | 0.4 | ◯ | 140 | 600 |
| | 3 | 98.5 | | | | |
| Comp. | 200 | — | 3.5 | X | Immeasurable (*1) | <200 |
| Ex. 1 | 30 | 35.0 | | | | |
| Comp. | 200 | — | 4.3 | X | Immeasurable (*1) | <200 |
| Ex. 2 | 35 | 28.0 | | | | |

(*1): Immeasurable due to dyeing

TABLE 3

| | Evaluation 7 |
|---|---|
| Example 1 | ⊚ |
| Example 2 | ⊚ |
| Example 3 | ⊚ |
| Example 4 | ⊚ |
| Comparative Example 1 | X |
| Comparative Example 2 | X |

1. An antireflective laminate comprising a light-transparent base material and a low-refractive index layer provided on the light-transparent base material, wherein
said low-refractive index layer is provided directly on a surface of light-transparent base material or is provided on the outermost surface of one or two or more optional layers provided on the surface of the light-transparent base material, and
said low-refractive index layer comprises hydrophobitized fine particles having an average particle diameter of not less than 5 nm and not more than 300 nm, and a binder.

2. The antireflective laminate according to claim 1, wherein said low-refractive index layer comprises a first layer formed of said fine particles and said binder and a second layer formed of said binder alone provided on the first layer, and the outermost surface of the low-refractive index layer has been rendered smooth.

3. The antireflective laminate according to claim 1, wherein the treatment for hydrophilizing the fine particles is carried out by treating the fine particles with a low-molecular organic compound, by treating said fine particles with a high-molecular compound, by treating said fine particles with a coupling agent, or by subjecting said fine particles to graft treatment with a hydrophobilic polymer.

4. The antireflective laminate according to claim 1, wherein said fine particles are not fully wetted with water.

5 The antireflective laminate according to claim 1, wherein said binder comprises an ionizing radiation curing resin.

6. The antireflective laminate according to claim 5, wherein at least one of functional groups contained in said ionizing radiation curing resin is a hydroxyl group.

7. The antireflective laminate according to claim 1, wherein said low-refractive index layer further comprises a fluorocompound and/or a silicon compound.

8. The antireflective laminate according to claim 7, wherein said fluorocompound is a compound containing a perfluoroalkyl, perfluoroalkylene, perfluoroalkyl ether, or perfluoroalkenyl group, or a mixture of compounds containing said groups.

9. The antireflective laminate according to claim 7, wherein said fluorocompound or/and said silicon compound is a compound represented by formula (I): 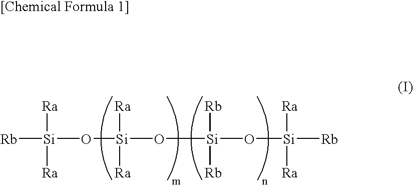
wherein
Ra represents an alkyl group having 1 to 20 carbon atoms,
Rb represents an unsubstituted alkyl group having 1 to 20 carbon atoms, or an amino, epoxy, carboxyl, hydroxyl, perfluoroalkyl, perfluoroalkylene or perfluoroalkyl ether group, or an (meth) acryloyl group-substituted alkyl group having 1 to 20 carbon atoms, an alkoxy group having 1 to 3 carbon atoms, or a polyether-modified group,
Ra and Rb may be the same or different,
m is an integer of 0 to 200, and
n is an integer of 0 to 200.

10. The antireflective laminate according to claim 7, wherein said fluorocompound and/or said silicon compound are represented by formula (II):
RcₖSiX₄₋ₖ (II)
wherein
Rc represents a hydrocarbon group having 3 to 1000 bon atoms and containing a perfluoroalkyl, fluoroalkylene, or perfluoroalkyl ether group,
X represents an alkoxy, oxyalkoxy, or halogen group having 1 to 3 carbon atoms, and
k is an integer of 1 to 3.

11. The antireflective laminate according to claim 1, wherein said low-refractive index layer has a contact angle with water of not leas than 90°.

12. The antireflective laminate according to claim 1, wherein the refractive index of the low-refractive index layer is not more than 1.45.

13. The antireflective laminate according to claim 1, wherein, in a planar area of 5 μm² in the outermost surface of the low-refractive index layer,
the ten-point mean roughness (Rz) is not more than 100 nm, and
the arithmetical mean roughness (Ra) is not less than 1 nm and not more than 30 nm.

14. The antireflective laminate according to claim 1, wherein a hardcoat layer is further provided as said optional layer.

15. The antireflective laminate according to claim 14, wherein said hardcoat layer has a refractive index of not less than 1.57 and not more than 1.70.

16. The antireflective laminate according to claim 14, wherein said hardcoat layer further comprises an anti-dazzling agent,

17. The antireflective laminate according to claim 1,
wherein
an antistatic layer is further provided as the optional layer, and
said antistatic layer is provided between said light-transparent base material and said low-refractive index layer or said hardcoat layer, or between said hardcoat layer and said low-refractive index layer.

18. The antireflective laminate according to claim 1,
wherein
an anti-dazzling layer Is further provided as the optional layer, and
said anti-dazzling layer is provided between said light-transparent base material and said low-refractive index layer or said hardcoat layer.

19. The antireflective laminate according to claim 1,
wherein
one or at least two other refractive index layer is further provided as the optional layer,
said other refractive index layer is formed between said hardcoat layer and said low-refractive index layer,
the refractive index of said other refractive index layer is more than 1.45 and not more than 2.00, and
the thickness of said other refractive index layer is not less than 0.05 μm and not more than 0.15 μm.

20. The antireflective laminate according to claim 1, wherein at least one layer selected from the group consisting of said low-refractive index layer, said hardcoat layer, said anti-dazzling layer, and said other refractive index layer contains an antistatic agent.

21. The antireflective laminate according to claim 1,
wherein
an anti-fouling layer is further provided as said optional layer, and
said anti-fouling layer is provided on the surface of said light-transparent base material remote from said low-refractive index layer.

22. The antireflective laminate according to claim 1, wherein, after wiping off the surface of the antireflective laminate with water or an alkaline liquid composition with a pH value of 9 or higher, the reflectance, transmittance, and scratch resistance of the antireflective laminate remains unchanged from those of the antireflective laminate berore the wiping-off.
